(19) United States
(12) Patent Application Publication
(10) Pub. No.: US 2022/0065747 A1
(43) Pub. Date: Mar. 3, 2022

(54) METHOD FOR MONITORING THE SERVICE LIFE OF AN INSTALLED ROLLING BEARING

(71) Applicant: AVL List GmbH, Graz (AT)

(72) Inventors: Gerhard Zalar, Unterpremstätten (AT); Joachim Schmidt, Werndorf (AT); Silvio-Leon Koiser, Gratwein (AT)

(21) Appl. No.: 17/418,241

(22) PCT Filed: Dec. 27, 2019
(86) PCT No.: PCT/AT2019/060449

§ 371 Date: Jun. 25, 2021

(30) Foreign Application Priority Data
Dec. 27, 2018 (AT) A 51156/2018

(51) Int. Cl. G01M 13/045; F16C 19/52; G01M 7/08

(52) U.S. Cl. CPC G01M 13/045; F16C 2233/00; G01M 7/08; F16C 19/522

(57) ABSTRACT

Various embodiments of the present disclosure are directed to devices and methods for monitoring service life of an installed rolling bearing. In one example embodiment, a methods is disclosed wherein measurements are recorded in a region around the bearing using at least two sensors, and remaining service life is calculated. The step of calculating remaining service life includes determining at least one transfer function, and determining, using the at least one transfer function and the recorded measurements of the at least two sensors, at least dynamic loads on the rolling bearing.

The invention relates to a method for monitoring the service life of an installed rolling bearing, in which, in a first step, measurements are recorded in the region around the bearing using at least two sensors and, in a subsequent step, a remaining service life is calculated.

It is currently common practice to predict the remaining service life of a rolling bearing or the case of damage on the basis of measurements with a sensor. The condition of the rolling elements can be assessed on the basis of the sound emissions that occur and, for example, maintenance or replacement is initiated if certain events occur.

The disadvantage here is that no precise predictions of the remaining service life are possible. Rather, an indication of premature failure is only given from the noticeable occurrence of incipient damage. As a result, the device often comes to an unplanned standstill.

Furthermore, a measurement directly on the rolling bearing is unfortunately often only achievable with major modifications at great expense.

It is the object of the present invention to provide a method for monitoring the service life that enables a better prediction of the remaining service life.

According to the invention, this object is solved by the aforementioned method for monitoring the service life of an installed rolling bearing by determining a transfer function and using this to determine at least dynamic loads—preferably all loads—on the rolling bearing from the measurements of the at least one sensor for calculating the remaining service life.

Furthermore, the object is solved by a device for monitoring the service life of an installed rolling bearing for carrying out the method of monitoring, having at least two sensors for measurement, wherein the sensors are arranged in the region of the bearing and a remaining service life is calculated in a subsequent step.

After calculating the remaining service life, this is output. The output takes place on a technical output device, visually on a screen or in electronic form in a memory or is output via a printer in printed form. The output device can be realized by a screen, a printer or similar devices.

Using the transfer function, it is possible to obtain accurate results for the loads on the rolling bearing without the need for the sensors to be in direct contact with the rolling bearing. The sensors can be placed away from the bearing rings.

This transfer function increases the accuracy of the determined values, since stiffnesses and yielding of the material, which influence the measurement, are taken into account.

This transfer function allows the remaining service life to be determined in a simple manner. No modifications to rolling bearings are necessary and good measurements are still obtained.

In a favorable variant of the method, the sensors are arranged outside an inner bearing ring and outside an outer bearing ring and dynamic properties of the bearing rings are recorded with the transfer function.

Due to the arrangement of the sensors outside the loaded areas, the durability of the sensors and subsequently the consistency of the accuracy increases over a longer period of time. Due to the constant rolling over of rolling elements, the sensors can be damaged over time and the measurements thus become unusable. This is achieved by placing the sensors in areas not overrun by rolling elements.

It is particularly advantageous if the sensors are arranged on a bearing shield and dynamic properties of the bearing shield are recorded with the transfer function. The bearing shield is the component that covers the rolling bearing from the outside in the axial direction and protects it from environmental influences such as the introduction of dust. The aging and contamination of lubricants is thus reduced to a minimum, e.g. through abrasion that cannot be prevented. The ideal utilization of the advantages occurs when all sensors are arranged outside an inner bearing ring and an outer bearing ring, for example on the bearing shield.

For particularly easy and accurate as well as inexpensive determination, the transfer function is determined using an impulse hammer, which has a force sensor for recording a signal and determines the sensors. An impulse hammer is a common device that is easily available, inexpensive and accurate.

Alternatively, the transfer function is determined using a vibration exciter that has a force sensor to pick up a signal and the sensors.

It is particularly easy to process the determined signals in this way if an excitation spectrum is determined from the signal of the force sensor of the impulse hammer or the vibration exciter—preferably with Fast Fourier Transformation (FFT). This can be done particularly easily with FFT.

The same advantage results when a response spectrum is determined from the signals of each sensor—preferably with FFT.

In a favorable alternative, it is provided that the sensors for measurement are acceleration sensors and that the acceleration sensors measure the acceleration in the region of the rolling bearing preferably at a recording rate of at least 2.56 kHz and/or that a frequency spectrum of the acceleration signal is determined in each case—preferably with FFT. With the aid of the acceleration sensors, dynamic loads on the rolling bearing can be determined very easily and precisely. Acceleration sensors are now available at low cost and in many different versions for a wide range of applications.

The method according to the invention is in particular computer-assisted or is carried out in particular in a computer-assisted manner.

In order to reduce the amount of data to be stored, one alternative of the method provides that frequency spectra of the acceleration signal—preferably with FFT—are determined at fixed intervals.

The load on the rolling bearing can be determined particularly easily and without much effort by determining a sum level from a force spectrum, wherein the force spectrum is determined as the quotient of the frequency spectrum of the acceleration signal and the transfer function.

A favorable alternative to acceleration sensors is the possibility of using strain gauges. In this case, the sensors for measurement are each a measuring arrangement with several strain gauges and each measuring arrangement measures the force in the region of the rolling bearing.

Temperature effects can be favorably compensated if the measuring arrangement has a Wheatstone bridge for each spatial direction and absorbs forces in all three spatial directions. This allows the measurement accuracy to be greatly increased.

In order to also be able to take static loads into account, one alternative provides for a tensioning device to be used to calibrate for static loads—and preferably dynamic loads up to a limit frequency.

The signals can be processed well if a frequency spectrum of a force signal is determined—preferably with FFT.

The amount of data can be reduced if frequency spectra of the force signal are determined at fixed intervals—preferably with FFT.

It is particularly easy to determine the bearing load if a sum level is determined from a force spectrum, wherein the force spectrum is determined as a quotient of the frequency spectrum of the force signal and the transfer function and/or if loads are summed from the static loads and the sum level of the force spectrum.

In order to increase the safety and the service life of the entire system, it is provided in a favorable variant that the calculation of the remaining service life is carried out continuously—preferably at intervals.

This can be further increased if a warning is issued when a lower limit value of the remaining service life is reached and/or if maintenance is initiated.

With the method according to the invention, it is possible to measure the forces acting in rolling bearings without having to make any design changes to the machine.

The forces measured during operation serve as the basis for an adaptive calculation of the remaining service life. Depending on the loads applied, the predicted service life is shortened or extended.

The method is particularly suitable for test stand dynamometers, but can also be used for other arrangements with installed rolling bearings. In principle, it can be used for all machines equipped with shafts or elements supported by rolling bearings.

The measurement of the forces acting during operation can be carried out in two different ways: On the one hand, by measuring the vibration using acceleration sensors and converting the acceleration of the vibration into force using the transfer function. The transfer function must be determined beforehand once for the bearing shield or the respective component on which the sensors are arranged.

On the other hand, the determination can be carried out by applying strain gauges (DMS) to the bearing shield or other component and with calibration by means of a calibration device. Furthermore, a transfer function must be calculated and implemented to take into account the dynamic properties of the bearing shield or the respective component.

The measurement by acceleration sensors is carried out in such a way: The transfer function is determined by means of an impulse hammer and an acceleration sensor. The impulse hammer, which has a force sensor at the tip, is used to strike the shaft and at the same time the response is measured at the acceleration sensors. A spectrum is calculated from these signals using FFT, and then the transfer function H(f) is determined for each acceleration sensor. Here, the spectrum from the acceleration sensors is called the response spectrum V(f) and the spectrum from the force sensor signal is called the excitation spectrum U(f). The transfer function H(f) is obtained as follows:

$$H ( f ) = \frac{V ( f )}{U ( f )} \begin{matrix}H ( f ) & Transfer function \\ U ( f ) & Fourier transformation of the excitation [ N ] \\ V ( f ) & Fourier transformation of the response [ m / {s}^{2} ]\end{matrix}$$

As can be seen, the transfer function has the unit

$$[ H ( f ) ] = \frac{m / {s}^{2}}{N} .$$

The measurements in operation are then carried out in such a way that the acceleration sensors are mounted as close as possible to the rolling bearing on the bearing shield of the machine or at measuring points provided for this purpose. To ensure that the signal of up to 1 kHz can be evaluated, the measurement is performed at a sufficiently high recording rate of more than 2.56 kHz. Frequency spectra are calculated from the continuously recorded acceleration signal by means of FFT at regular intervals, which may be fixed in time. These are then spectrally divided by the previously determined transfer function H(f). The result is a force spectrum F(f) according to the formula below:

$$F ( f ) = \frac{a ( f )}{H ( f )} \begin{matrix}H ( f ) & Transfer function \\ F ( f ) & Force spectrum [ N ] \\ a ( f ) & Spectrum of acceleration signal [ m / {s}^{2} ]\end{matrix}$$

The sum level of this force spectrum F(f) reflects the total force acting in the rolling bearing.

When using strain gauges, these are arranged on the bearing shield in such a way that the force can be measured in all three spatial directions. To find the ideal position, a finite element calculation of the structure is performed. The ideal position means the most accurate separation possible of the measured spatial directions with the highest measurement sensitivity. For each spatial direction, a Wheatstone measuring bridge is necessary, i.e. four strain gauges are provided for each direction.

By positioning the strain gauges on the inside and outside of the bearing shield and arranging them in the Wheatstone measuring bridge, it is possible to separate the measuring directions (axial, horizontal, vertical) with minimal crosstalk. The crosstalk depends on the quality (accuracy of the wall thicknesses, homogeneity of the casting) of the bearing shield. If high accuracy is required, the bearing shield is favorably designed as a steel turned part.

The strain gauges are calibrated using a specially manufactured clamping device that can exert tension on the shaft in all three spatial directions. A force sensor is mounted between the shaft and the clamping device, which measures the tensile force exerted. At the same time, the voltages of the full bridges are measured and recorded. The calibration factor f results from:

$$f = \frac{Δ U}{Δ F} \begin{matrix}f … & Calibration factor V / N \\ Δ U … & Voltage difference from two measured values \\ Δ F … & Force difference from two measured values\end{matrix}$$

As soon as the machine rotates, forces are generated in the rolling bearing due to various influences, such as the unbalance. These forces lead to a deformation of the bearing shield and thus to an absorption of forces at the strain gauge. As a result, the acting force can be measured.

Above a certain frequency range, the static calibration leads to larger deviations and, as with the variant with the acceleration sensors explained first, a transfer function H(f) must be introduced to correct the dynamic properties of the bearing shield.

In principle, the measurement can be performed in the same way as described above, with the difference that the response is the force signal from the strain gauge measurement.

Excitation can also be provided by an impulse hammer or by means of a vibration exciter that also measures the applied force with a force sensor.

The ISO 281 standard is usually used for the service life calculation of rolling bearings. In this standard, the mechanical specifications of the rolling bearing and the operating conditions serve as the basis for calculation.

In order to calculate the remaining service life, use is made of a dynamically equivalent bearing load P. In addition, a dynamic load rating C, which varies from rolling bearing to rolling bearing, is used. An operating speed n and a service life exponent are also used in the equation for the basic rating life L₁₀ₕ. L₁₀ₕ indicates the basic rating life at 90% probability of occurrence in operating hours h. The basic rating life L₁₀ₕ in operating hours h is therefore calculated as follows:

$${L}_{10 h} = \frac{16666}{n} \cdot {( \frac{C}{P} )}^{p}$$

$$C … D ynamic load rating$$

$$P … Dynamic equivalent bearing load for radical and$$

$$axial bearings$$

$$p … Service life exponent ; for rolling bearings \text{:}$$

$$10 / 3 ; for ball bearings \text{:} p = 3$$

$$n … Operating speed$$

$$\text{?}$$

$$\text{?} \text{indicates text missing or illegible when filed}$$

The remaining service life is conveniently displayed in remaining operating hours h. This means that service can be initiated in good time before damage and downtime occur, or an alarm can be issued, for example.

The dynamically equivalent bearing load P is a calculated value. This value is a radial load constant in magnitude and direction for radial bearings or axial load for axial bearings. A load with the dynamic equivalent bearing load P results in the same service life as the actually acting combined load in axial direction Fₐ and in radial direction Fᵣ.

P=X·Fᵣ+Y·Fₐ

The force is measured in two directions. The equivalent dynamic bearing load P is obtained by means of bearing-specific factors X and Y and the measured forces in the axial direction and in the radial direction. The factors X and Y are usually provided in product catalogs by the bearing manufacturer.

The adaptive service life calculation is then carried out using the basic dynamic load rating C with the dynamic equivalent bearing load P for radial and axial bearings given above. The service life exponent p for rolling bearings is used with p=10/3 and for ball bearings with p=3.

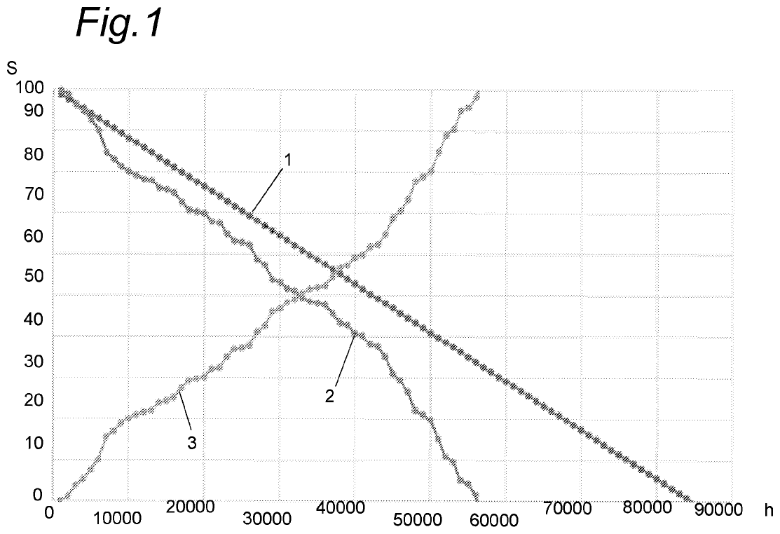

With reference to the design of the rolling bearing, where load and speed spectra are assumed, the service life decreases faster or slower after each calculation based on the current speed and the currently acting forces. This means that a gradient of a service life curve, as shown in FIG. 1, is larger or smaller. The gradient is used to calculate the reduction of the service life until the next calculation interval.

The same result is obtained when using the service life calculation L₁₀ₕ to determine a Wöhler curve, which states how many million revolutions the rolling bearing can withstand at loads from 0 Newton up to the load rating C. In the subsequent determination of the ratio Dᵢ=nᵢ/Nᵢ, the partial damage per calculation cycle is determined.

Dᵢ . . . Partial damage

nᵢ . . . Number of revolutions at current load in the calculation cycle

Nᵢ . . . Tolerable revolutions at current load

The sum of all partial damages gives the total damage D:

D=Σᵢ₌₀^{k}ni/Ni.

When the total damage reaches D one, 100% damage is reached.

In the following, the invention is explained in more detail with reference to the following figures, wherein:

FIG. 1 shows a progression of a service life and a damage reserve over operating hours h;

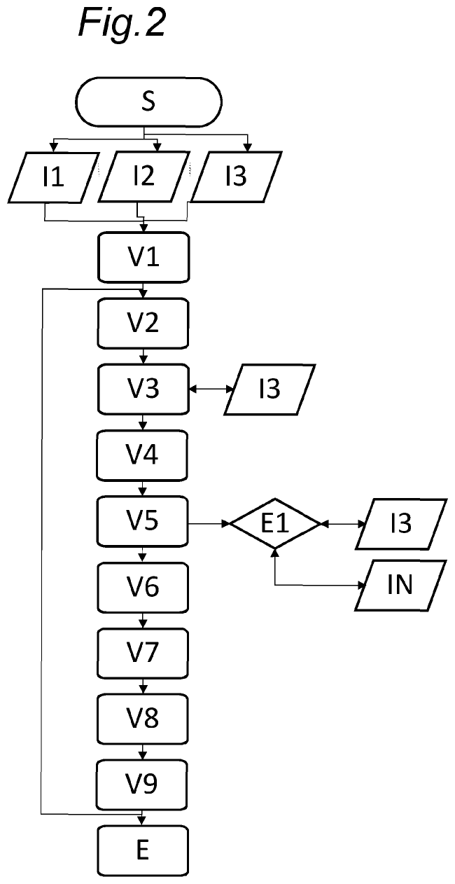

FIG. 2 shows a service life calculation using the method according to the invention; and

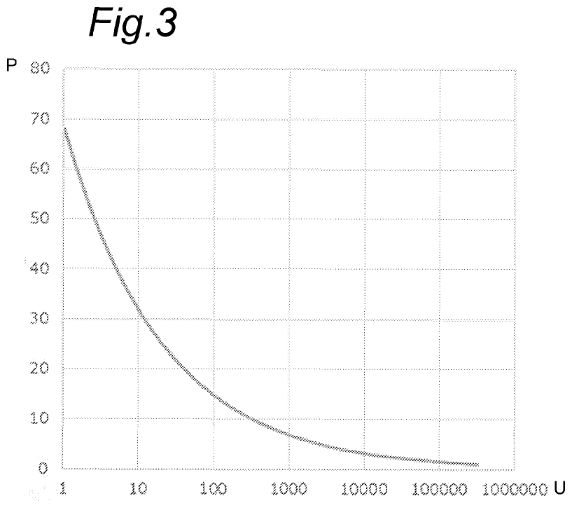

FIG. 3 shows an exemplary Wöhler line.

FIG. 1 shows an adaptive service life calculation and damage accumulation. Here, a remaining damage reserve S is plotted over the operating hours h. A first line 1 shows the predicted service life L at a predetermined speed n. The assumption here is that the load and speed n are constant over the operating hours h. The assumption here is that the load and the speed n remain constant over the entire service life L. In the case shown, the service life L is approximately 85,000 hours.

A second line 2 indicates the service life in %, wherein this service life was determined by means of a gradient.

A third line 3 indicates a damage accumulation in % determined by means of Wöhler line.

FIG. 2 shows an example of an adaptive service life calculation using the service life calculation method according to the invention. A schematic of the procedure of the method is shown. The service life calculation starts in S. Then the measured data are entered in I1, I2 and I3. In I1, the force in radial direction Fᵣ, the force in axial direction Fₐ and the elapsed time Δt are entered into the calculation. In I2, constants are taken into account, such as the basic dynamic load rating C, the basic static load rating C₀, a factor for deep groove ball bearings f₀ according to the rolling bearing catalog, the nominal service life in hours L_{10h,nom} and a service life coefficient a₁. Optionally, further values can be entered. In I3, values from tables are entered, such as table 3 of ISO 281 for the inclusion of values for the bearing-specific factors X and Y as well as calculation factor e.

In method step one V1, a service life in percent of currently 100% is assumed. Furthermore, the first service life determination starts in method step two V2 by calculating the ratio f₀*Fₐ/C₀. By means of this ratio, for example, the calculation factor e can be read out from Table 3 of ISO 281, marked here as I3, in method step three V3. However, as an alternative to Table 3 of ISO 281, another origin of the table can be used for reading out the factors. This procedure corresponds to the current common practice for the service life calculation of rolling bearings.

In method step four V4, the ratio Fₐ/Fᵣ between the dynamic force in axial direction Fₐ and the dynamic force in radial direction F_{Fr} is calculated.

Then the factors X and Y are determined in method step five V5. For this purpose, the decision E1 takes place with which is determined whether the ratio Fₐ/Fᵣ is larger e. If it is, then the factors of X and Y are entered from the table entered in I3. If the ratio Fₐ/Fᵣ is smaller than the calculation factor e, then the value 1 is used for the factor X and the value 0 for the factor Y.

In method step six V6, the equivalent dynamic bearing load P is calculated using the formula given above. Subsequently, the service life L_{10h,current} is calculated as a₁*(C/P)\hat{ }3*10\hat{ }6/60/n and the gradient k with k=100%/L₁₀ₕ*(−1) in method step seven V7. The calculation of a new service life in percent L_{10%,current} is carried out in method step eight with L_{10%,new}=k*Δt+L_{10%,current} and setting of the new values L_{10%,current}=L_{10%,new}. In method step nine V9, the service life is displayed as L_{10h,nom}/100*L_{10%current} in hours.

As a result of the feedback after method step nine V9 before method step two V2, the calculation takes place again. Until the end of the service life E is reached, this method can be repeated. With the end E, a warning can be issued and/or maintenance or replacement of the bearing can be initiated.

FIG. 3 shows a Wöhler curve of the maximum possible load over millions of revolutions. The Wöhler curve is calculated using the formula L₁₀=(C/P)^{p}. It indicates how many million revolutions U the bearing can withstand at a given load P in kN.

1. Method for monitoring the service life of an installed rolling bearing, the method including the steps of:
recording measurements in a region around the bearing using at least two sensors, and
calculating a remaining service life includes
determining at least one transfer function
determining, using the at least one transfer function and the recorded measurements of the at least two sensors, at least dynamic loads.

2. The method according to claim 1, wherein the at least two sensors are arranged outside an inner bearing ring and an outer bearing ring, and the transfer function is indicative of dynamic properties of the inner and outer bearing rings.

3. The method according to claim 2, wherein the at least two sensors are further arranged on a bearing shield and the transfer function is indicative of dynamic properties of the bearing shield.

4. The method according to claim 1, wherein the step of determining the transfer function further includes using an impulse hammer having a force sensor for recording a signal and using the sensors.

5. The method according to claim 1, wherein the step of determining the transfer function further includes using a vibration exciter having a force sensor for recording a signal and using the sensors.

6. The method according to claim 4, further including the step of determining an excitation spectrum from the signal of the force sensor of the impulse hammer using Fast Fourier Transformation.

7. The method according to claim 1, further including the step of determining a response spectrum from each of the signals of the sensors.

8. The method according to claim 1, wherein the sensors for measurement are acceleration sensors and further including the step of measuring the acceleration in the form of an acceleration signal via the acceleration sensors.

9. The method according to claim 8, further including the step of determining a frequency spectrum of the acceleration signal.

10. The method according to claim 9, further including the step of determining frequency spectra of the acceleration signal at fixed intervals.

11. The method according to claim 9, further including the step of determining a sum level from a force spectrum, wherein the force spectrum is determined as a quotient of the frequency spectrum of the acceleration signal and the transfer function.

12. The method according to claim 1, wherein the at least two sensors each have a measuring arrangement with several strain gauges, and each measuring arrangement is configured and arranged to measure the force in the region of the rolling bearing.

13. The method according to claim 12, wherein each measuring arrangement has a Wheatstone measuring bridge for each spatial direction and absorbs forces in all three spatial directions.

14. The method according to claim 12, further including the step of carrying out a calibration for static loads and the dynamic loads up to a limit frequency with a clamping device.

15. The method according to claim 14, wherein a frequency spectrum of a force signal is determined.

16. The method according to claim 15, further including the step of determining frequency spectra of the force signal at fixed intervals.

17. The method according to claim 16, further including the step of determining a sum level from a force spectrum, wherein the force spectrum is determined as quotients of the frequency spectrum of the force signal and the transfer function.

18. The method according to claim 17, further including the step of summing loads from the static loads and the sum level of the force spectrum.

19. The method according to claim 11, wherein the calculation of the remaining service life is carried out continuously.

20. The method according to claim 11, wherein a warning is output when a lower limit value of the remaining service life is reached.

21. Device for monitoring the service life of an installed rolling bearing, the device comprising:
at least two sensors arranged in a region of the rolling bearing, the at least two sensors configured and arranged to record measurements in the region around the bearing, and
wherein a remaining service life is calculated using at least one transfer function and the measurements of the at least two sensors.
